(19) United States
(12) Patent Application Publication
(10) Pub. No.: US 2024/0275111 A1
(43) Pub. Date: Aug. 15, 2024

(54) CONTACT PIN FOR A PLUG CONNECTOR, PLUG CONNECTOR AND METHOD OF MANUFACTURING A CONTACT PIN AND A CORRESPONDING PLUG CONNECTOR

(71) Applicant: TE Connectivity Solutions GmbH, Schaffhausen (CH)

(72) Inventors: Gregor PANITZ, Bensheim (DE); Hartmut PAULUS, Woert (DE); Michael REIBER, Woert (DE); Carsten BICHELS, Woert (DE); Marc REINHARDT, Bensheim (DE); Christian RUSCH, Bensheim (DE); Bert BERGNER, Bensheim (DE); Uwe LUTZ, Woert (DE)

(21) Appl. No.: 18/438,984

(22) Filed: Feb. 12, 2024

(30) Foreign Application Priority Data
Feb. 15, 2023 (DE) 102023103726.9

(51) Int. Cl. H01R 24/44; H01R 103/00

(52) U.S. Cl. CPC H01R 24/44; H01R 2103/00

(57) ABSTRACT

A contact pin for a plug connector includes a contact wire and an impedance adaptation element from a residual piece of a bandoleer strip, wherein the impedance adaptation element is arranged between the two ends of the contact wire. A plug connector includes the contact pin and a shielding receiving the contact pin as an inner conductor, wherein the shielding has a cross-sectional jump between the two ends of the contact pin along a longitudinal direction of the shielding, wherein the impedance adaptation element of the contact pin is arranged in a longitudinal direction of the contact wire at a level of the cross-sectional jump of the shielding. Manufacturing methods are provided for such a contact pint and plug connector.

### CROSS REFERENCE TO RELATED APPLICATIONS

This application claims the benefit of DE Application No. 102023103726.9, filed 15 Feb. 2023, the subject matter of which is herein incorporated by reference in its entirety.

### BACKGROUND OF THE INVENTION

The subject matter herein relates to a contact pin for a plug connector and a method for manufacturing a contact pin and/or plug connector.

Coaxial cables are 2-pole cables with a concentric structure. They consist of an inner conductor that is surrounded at a constant distance by a hollow cylindrical outer conductor-also known as shielding. The outer conductor shields the inner conductor from interference radiation. Coaxial cable are typically used in the high-frequency range for the signal transmission. For example, sound signals and/or image signals can be transmitted via coaxial cables. Coaxial cables have a wave impedance that is typically 75 ohms (e.g. for video transmission) or 50 ohms, depending on the use case. What is decisive for the wave impedance (also known as impedance) is the distance between the inner conductor and the outer conductor as well as the material in this gap. A change in the distance of the inner conductor to the outer conductor therefore results in a change in impedance. To ensure a signal transmission as loss-free as possible, the wave impedance should remain constant over the entire transmission path. Coaxial cables typically have plug connectors at their ends, via which they are connectable to other electrical components for further signal processing. Such a plug connector usually comprises a contact pin, which corresponds in its function to the inner conductor of the coaxial cable, and a shielding that receives the contact pin. The one end of the contact pin is designed to be connectable to the coaxial cable. The other end of the contact pin is designed to be connectable to another electrical component-for example a socket on a circuit board. The transfer point between the coaxial cable of the other electrical component is also referred to as the interface of the coaxial line. Typically, signal losses occur at such interfaces, because, due to installation space, changes occur in the distance between the inner conductor and the outer conductor or the dielectric medium located between them.

In the mass production of plug connectors, contact pins are made from contact wires. Typically, the contact wires are held in a bandoleer strip to simplify their handling. In the simplest sense, a bandoleer strip respectively a bandoleer band is an elongated band that has along the longitudinal direction of the band sleeves arranged adjacent to each other. The surface of the bandoleer strip is usually designed electrically conductive. Individual contact pins respectively contact wires each can be accommodated in the neighboring sleeves of the bandolier strip. Thereby, both ends of a contact wire can protrude beyond the bandolier strip. To produce a plug connector and a contact pin, the contact wire is taken out from the bandoleer strip.

There is a need for a contact pin that is easy to manufacture, easy to handle and that reduces signal losses.

### BRIEF DESCRIPTION OF THE INVENTION

In an embodiment, a contact pin for a plug connector is provided that includes a contact wire and an impedance adaptation element from a residual piece of a bandoleer strip, wherein the impedance adaptation element is arranged between the two ends of the contact wire.

Advantageously, the residual piece on the contact wire increases the conductive surface of the contact pin and at the same time the expansion of the contact pin transverse to the longitudinal direction of the contact wire at a level of the residual piece. In the following explanations, the term residual piece (of the bandoleer strip) is used synonymously for the impedance adaptation element.

Alternatively or cumulatively, the residual piece of the bandoleer strip comprises a holding section holding the contact wire and a mold section connected to the holding section via a material bridge and serving to adapt the impedance. Both ends of the contact wire preferably protrude beyond the residual piece, because the contact wire penetrates the holding section.

Alternatively or cumulatively, the material of the residual piece consists of an electrically conductive material or galvanisable material. Preferably, it consists of copper with a lower purity content than the contact wire.

Alternatively or cumulatively, the contact wire has a round or rectangular cross-section. In particular, the contact wire can be designed straight.

According to a further advantageous embodiment, the mold section consists of a residual of a cut-out band section of the bandoleer strip. Advantageously, such a mold section simplifies the production of the contact pin, in that it saves resources and at the same time reduces signal losses. The mold section thereby corresponds to a band section of the bandoleer strip that extends in a longitudinal direction of the bandoleer strip. Before the cut-out, the mold section of the residual piece is arranged adjacently to other mold sections of the bandoleer strip. In particular, the mold section was arranged adjacently to other mold sections in a longitudinal direction of the bandolier band.

Alternatively or cumulatively, the holding section of the residual piece is sleeve-shaped. Preferably, the contact wire penetrates the sleeve-shaped holding section at both ends of the residual piece.

Alternatively or cumulatively, the mold section comprises a plane-parallel board. The mold section thus extends transversely to a longitudinal direction of the contact wire. Advantageously, the extent of the contact pin transverse to a longitudinal direction of the contact wire is thereby increased.

Alternatively or cumulatively, the mold section has a curved shape in a cross-sectional plane perpendicular to the longitudinal direction of the contact wire. Preferably, the curved shape of the mold section extends in sections around the contact wire. According to a further advantageous embodiment, the mold section can embodied curve shaped . For example, the curve shape corresponds to a circular curve, a parabolic curve, an elliptical curve or a hyperbolic curve.

Alternatively or cumulatively, the mold section partially or completely encloses the contact wire.

According to a further advantageous embodiment, the center point of the contact wire in the cross-sectional plane perpendicular to the longitudinal direction of the contact wire is offset from a center point defining the curved shape of the mold section.

According to a further advantageous embodiment, the contact wire has a fastening section that is arranged flush along a longitudinal direction of the contact wire with the impedance matching element and at a distance from it.

Alternatively or cumulatively, the fastening section is embossed with indentations and/or protrusions.

According to another advantageous embodiment, the contact wire has a gradation towards one end. Due to the gradation, the cross-sectional expansion of the contact wire is reduced to one end of the contact wire. In other words, the diameter of the contact wire on the one side of the gradation is smaller than on the other side of the gradation.

Furthermore, the task underlying the subject matter herein is solved by a plug connector having a contact pin, wherein the plug connector-in addition to the contact pin-comprises a shielding receiving the contact pin as an inner conductor, wherein the shielding has a cross-sectional jump between the two ends of the contact pin along a longitudinal direction of the shielding and wherein the impedance adaptation element of the contact pin is arranged in a longitudinal direction of the contact wire at a level of the cross-sectional jump of the shielding.

The longitudinal direction of the contact wire can be essentially identical to respectively correspond to the longitudinal direction of the shielding.

Preferably, the shielding can serve as the outer conductor of a coaxial line, with the contact pin corresponding to the inner conductor of the coaxial line. Accordingly, the contact pin can be arranged coaxially respectively in the center of the shielding.

According to a further advantageous embodiment, a holding element can be located between the contact pin and the shielding, which is arranged flush along the longitudinal direction of the contact wire with the impedance adaptation element and at a distance from it. Preferably, the holding element can accommodate a fastening section of the contact pin. Advantageously, the holding element secures the position of the contact pin along the longitudinal direction of the contact wire relative to the shielding that holds the contact pin.

According to another advantageous embodiment, the plug connector can be connected to a high-frequency coaxial cable respectively-conductor.

According to a further advantageous embodiment, a seal is provided between the holding element and the impedance adaptation element. The seal can be an integral part of the holding element. Alternatively or cumulatively, the seal can be a sealing ring.

According to a further advantageous embodiment, the shielding has a section with a larger cross-section in a longitudinal direction after the cross-sectional jump than before the cross-sectional jump, wherein the section of the shielding with a larger cross-section partially or completely encloses at least the mold section of the contact pin.

Alternatively or cumulatively, the impedance adaptation element is adapted for a wave impedance of the plug connector of 50 ohms or 75 ohms.

Furthermore, the task underlying the subject matter herein is solved by a manufacturing method for the contact pin. The manufacturing method of the contact pin comprises providing a residual piece of a bandoleer strip fitted with a contact wire, wherein the contact wire is fastened in a holding section of the residual piece of the bandoleer strip and wherein the residual piece comprises a mold section connected to the holding section via a material bridge, and cutting and/or reshaping the mold section depending on a calculated value that serves to adapt the impedance. The holding section is preferably sleeve-shaped. The calculated value can be determined by a simulation depending on a shielding that accommodates the contact pin and has a cross-sectional jump. By adapting the mold section depending on the calculated value, the change in impedance, caused by the cross-sectional jump of the shielding, can be compensated.

Furthermore, the task underlying the subject matter herein is solved by a manufacturing method for the plug connector.

The manufacturing method of the plug connector includes: providing of a bandoleer strip fitted with contact wires, wherein respectively one contact wire is arranged in a respective holding section of the bandoleer strip; a cutting of the bandoleer strip at a cut-off line in order to obtain a residual piece of the bandoleer strip fitted with a contact wire, wherein the cut-off line on the bandoleer strip runs between two contact wires arranged adjacent in the longitudinal direction of the bandoleer strip; and an inserting of the residual piece of the bandoleer strip fitted with the contact wire into a shielding having a cross-sectional jump, wherein the residual piece is arranged in the longitudinal direction of the contact wire at a level of the cross-sectional jump of the shielding.

Preferably, there is exactly one contact wire in the residual piece of the bandoleer strip.

Advantageously, the residual piece of the bandoleer strip that has been cut off and fitted with the contact wire can already form the contact pin.

Alternatively or cumulatively, the shielding, accommodating the contact pin, can be cylindrical. In particular, the shielding can connect two hollow-cylindrically-formed segments via the cross-sectional jump.

According to a further advantageous embodiment, the residual piece additionally comprises a mold section serving to adapt the impedance, whereby the manufacturing process of the plug connector further comprises a reshaping of the mold section of the residual piece depending on a value corresponding to the cross-sectional jump of the shielding.

According to a further advantageous embodiment, the mold section of the residual piece has symmetry with respect to the longitudinal direction of the contact wire. For example, the mold section can be rotationally symmetrical with respect to the longitudinal direction of the contact wire. As already explained above, the mold section can be connected to the holding section of the residual piece via a material bridge.

According to a further advantageous embodiment, the residual piece fitted with the contact wire can serve as a guiding aid when inserting it into the shielding.

Preferably, the contact wires can penetrate the respective holding section in the bandoleer strip. As already explained, both ends of a contact wire can protrude beyond the holding section. Preferably, the holding section is embodied as sleeve shaped.

According to a further advantageous embodiment, the contact pin, produced from the manufacturing method described above for a contact pin, can alternatively instead of the residual piece of the bandoleer strip fitted with the contact wire be used in the manufacturing method of the plug connector. According to this embodiment, the manufactured contact pin is inserted into the shielding having the cross-sectional jump. Preferably, after inserting, the mold section of the contact pin is arranged at a level of the cross-sectional jump of the shielding.

Furthermore, the task underlying the subject matter herein is solved by a set of contact pins, wherein at least one impedance adaptation element of a contact pin is shaped geometrically different than an impedance adaptation element of another contact pin in the set of contact pins.

Furthermore, the task underlying the subject matter herein is solved by a set of plug connectors, wherein a first contact pin of the set of plug connectors has an impedance adaptation element shaped geometrically different than a second contact pin of the set of plug connectors.

The features described above can be used, even if this is not explicitly stated, both for the method or manufacturing method and for the contact pin or plug connector (both hereinafter also referred to as device). Thus, a process feature, only described explicitly in the context of the method, can also represent a device feature. Conversely, a device feature, only described explicitly in the context of the device, can also represent a method feature. A device, an arrangement or a unit can hereby correspond to a method step or a function of a method step. Similarly therewith, aspects that are described in the context of a method step also represent a description of a corresponding unit, arrangement, device or property thereof. The advantages described in relation to the device also apply to the method and vice versa.

The term “and/or” includes all combinations of one or more of the associated elements listed and can be abbreviated to “/”.

In the embodiments described above, the residual piece of the bandoleer strip serving for impedance adaptation can be electrically conductively connected to the contact wire. Preferably, the contact wire is electrically conductively connected to the residual piece over the entire length of the residual piece in the longitudinal direction of the contact wire.

In the following, the invention is described by means of advantageous embodiments with reference to the drawings in more detail by way of example. The advantageous developments and embodiments shown here are independent of each other and can be combined arbitrarily with each other as required in the use case. For the sake of simplicity, elements and functions that are present in several embodiments are only explained once, if necessary.

### BRIEF DESCRIPTION OF THE DRAWINGS

FIG. 1 shows a perspective view of the contact pin in accordance with an exemplary embodiment;

FIG. 2 shows a modification of the contact pin from FIG. 1;

FIG. 3A, 3B show a perspective view of a contact wire with a round or rectangular cross-section;

FIG. 4a shows a bandoleer strip fitted with contact wires;

FIG. 5a shows a side view of the contact pin;

FIG. 6 shows a flowchart of a manufacturing method of a contact pin;

FIG. 7 shows a flowchart of a manufacturing method of a plug connector;

FIG. 8 shows a top view of a bandoleer strip fitted with contact pins;

FIG. 9 shows a sectional view of a plug connector;

FIG. 10 shows a set of contact pins; and

FIG. 11 shows a set of plug connectors.

### DETAILED DESCRIPTION OF THE INVENTION

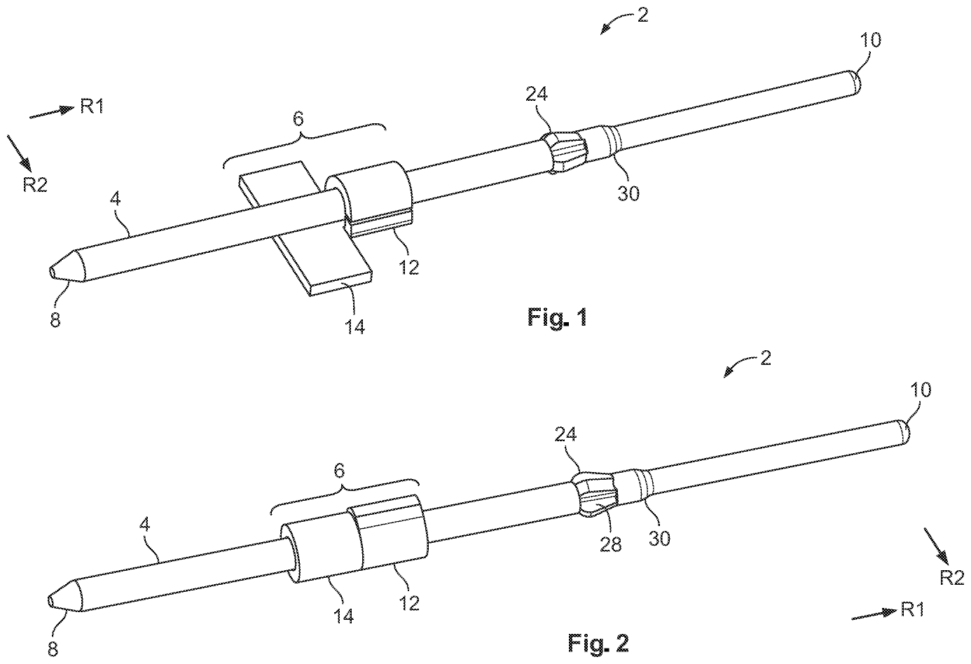

FIG. 1 shows an exemplary embodiment of the contact pin 2 in accordance with an exemplary embodiment. The contact pin 2 comprises a contact wire 4 and a residual piece 6 of a bandoleer strip. The contact wire is an electrical conductor that is generally made of metal. It is used to make electrical contact with two other electrically conductive components, each of which can be in contact with the two end points 8 and 10 of the contact wire 4. The lateral extent of the contact wire 4 is preferably constant between the two end points 8 and 10. Contact pins 2 are also used as inner conductor of a coaxial line. In this use case, the contact pin is enclosed by a shielding or an outer conductor of the coaxial line. Coaxial lines generally have an impedance of 50 ohms, in the high-frequency range the impedance is 75 ohms. In order to ensure a signal transmission as loss-free as possible, it is desirable for the impedance behavior of coaxial lines to remain constant over the entire length of the line. Already small deviations in the cross-section of the coaxial line can change the impedance behavior. Without components that compensate these cross-sectional deviations, signal losses occur.

The residual piece 6 of the bandoleer strip comprises two components. On the one hand, the residual piece 6 has a holding section 12, which is designed to hold the contact wire in a frictionally engaged manner. Preferably, the holding section 12 is embodied sleeve-shaped. Furthermore, the holding section 12 is connected to a mold section 14 of the residual piece 6 via a material bridge. Preferably, the mold section 14 is partially in contact with the contact wire in a longitudinal direction R1. In the embodiment of the contact pin 2 shown in FIG. 1, the mold section 14 extends transversely to the longitudinal direction R1 of the contact wire.

Since the bandoleer strip is made of a galvanisable or electrically conductive material, the residual piece 6 of the bandoleer strip is electrically conductively connected to the contact wire 4 at the holding section 12 and/or the mold section 14. Furthermore, since the residual piece 6 lies on the outside of the contact wire 4, the conductive cross-section of the contact pin 2 increases at the height at which the residual piece 6, in particular the mold section 14, contacts. The residual piece 6 of the bandoleer strip thus serves as an impedance adaptation element for the contact pin 2.

The use as an impedance adaptation element is particularly advantageous for coaxial lines.

For a coaxial cable and a corresponding plug connector for a coaxial cable, the impedance of the coaxial cable results from the ratio of the diameter of the inner conductor to the diameter of the outer conductor and from the electrical constant of the material between the inner conductor and the outer conductor.

Since the effective diameter of the contact pin 2 in the longitudinal direction of the contact wire at the height of the mold section 14 is larger than the diameter of the contact wire 4, a different impedance is obtained for a coaxial plug connector if the contact pin 2 is encompassed by an outer conductor or the shielding of a coaxial plug connector.

The contribution of the impedance adaptation by a contact pin can be further adapted by reshaping the mold section 14 depending on the use case.

Computer simulations such as the finite-element method can be used to calculate the geometry, dimension and shape of the mold section, depending on the use case.

Based on the calculated variables such as the shape, expansion or curvature of the mold section 14, the impedance behavior of the contact pin 2 can be adapted to the external circumstances, i.e. the used shielding of the contact pin 2. In the simplest case, the lateral expansion of the mold section 14 is adapted to the shielding receiving the contact pin 2 based on the calculated shape. The lateral expansion of the mold section 14 here refers to the expansion of the mold section 14 transverse to the longitudinal direction of the contact wire. Alternatively or cumulatively, the mold section 14 can be bent or deformed differently and thus serve, in interaction with the outer shielding of the contact pin 2, for impedance adaptation.

An alternative embodiment of the contact pin 2 is shown in FIG. 2. The mold section 14 of the residual piece 6 or the impedance adaptation element 6 shown in FIG. 2 differs from the mold section 14 shown in FIG. 1 in that the mold section 14 is bent around the contact wire 4. Preferably, the mold section 14 lies completely against the contact wire 4. In the cross-sectional plane relative to the longitudinal direction R1 of the contact wire, the inner contour of the mold section 14 corresponds to the outer contour of the contact wire 4 in the cross-sectional plane to the longitudinal direction R1 of the contact wire. In FIGS. 1 and 2, the contact wire 4 4 is respectively embodied as a round wire. This results in a circular shape for the contour of the mold section 14 shown in FIG. 2. Alternatively, the profile of the contact wire 4 can also be square or rectangular. For example, the contour of a mold section 14 for a contact wire 4 based on a square base also has the contour of a square.

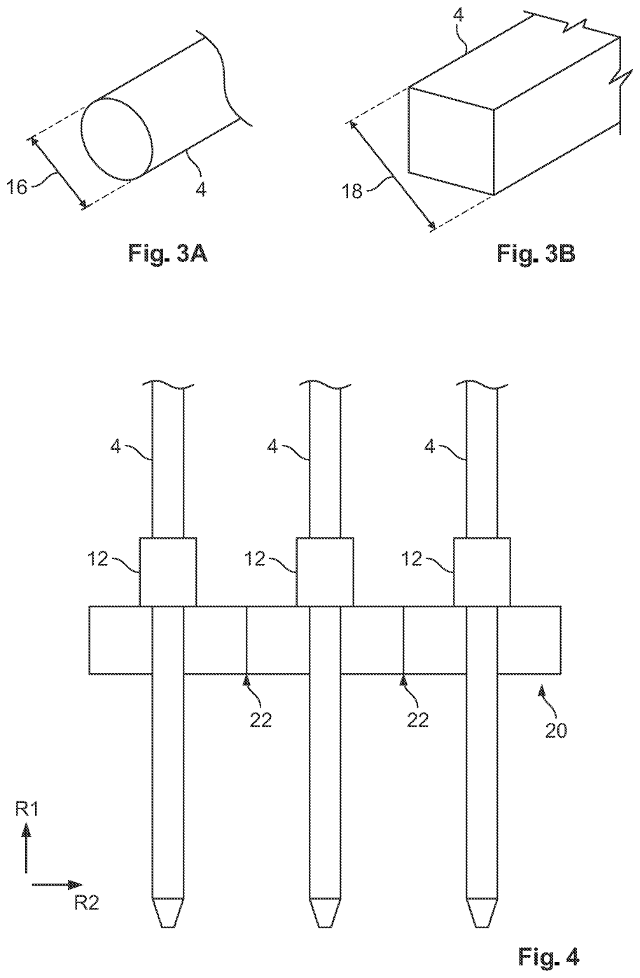

FIGS. 3A and 3B each show a perspective view of a contact wire 4. The contact wire 4 in FIG. 3A has a circular profile with a diameter 16 in a cross-section to the longitudinal direction R1 of the contact wire. The contact wire 4 in FIG. 3B, on the other hand, has a square profile in a cross-section to the longitudinal direction R1 of the contact wire. The effective diameter 18 of the contact wire 4 can in this case be determined as the diagonal between two opposite corner points of the wire.

FIG. 4 shows a bandoleer strip fitted with contact wires 4. The plurality of contact wires 4 is held at the respective holding section 12 in the bandoleer strip 20. The bandoleer strip 20 extends in a longitudinal direction R2 of the bandoleer band, wherein the contact wires 4 are arranged adjacent to each other in this direction R2. The longitudinal direction R2 of the bandolier band is essentially perpendicular to the longitudinal direction R1 of the contact wire.

The respective holding section 12 of the bandoleer strip 20 holding a contact wire 4 is preferably sleeve-shaped. Thus, the holding section 12 has two openings arranged opposite each other in the longitudinal direction R1 of the contact wire, through which a contact wire 4 can penetrate.

In the manufacturing method of the contact pin 2, the bandoleer strip is cut at a cut-off line 22. Cutting off can be carried out, for example, by cutting or punching. By cutting off the bandoleer strip 20, a residual piece 6 of the bandoleer strip 20 fitted with a contact wire 4 is obtained, which has a mold section 14 as shown in FIG. 1, which essentially corresponds to a plane-parallel board. The distance of the cut-off line 22 to the contact wire 4 may correspond to a calculated value adapted for a coaxial shielding accommodating the contact pin 2. In other words, the distance is calculated or determined in such a way that the impedance changes arising in interaction with the shielding accommodating the contact pin 2 are compensated for by the mold section 14 dimensioned in this way.

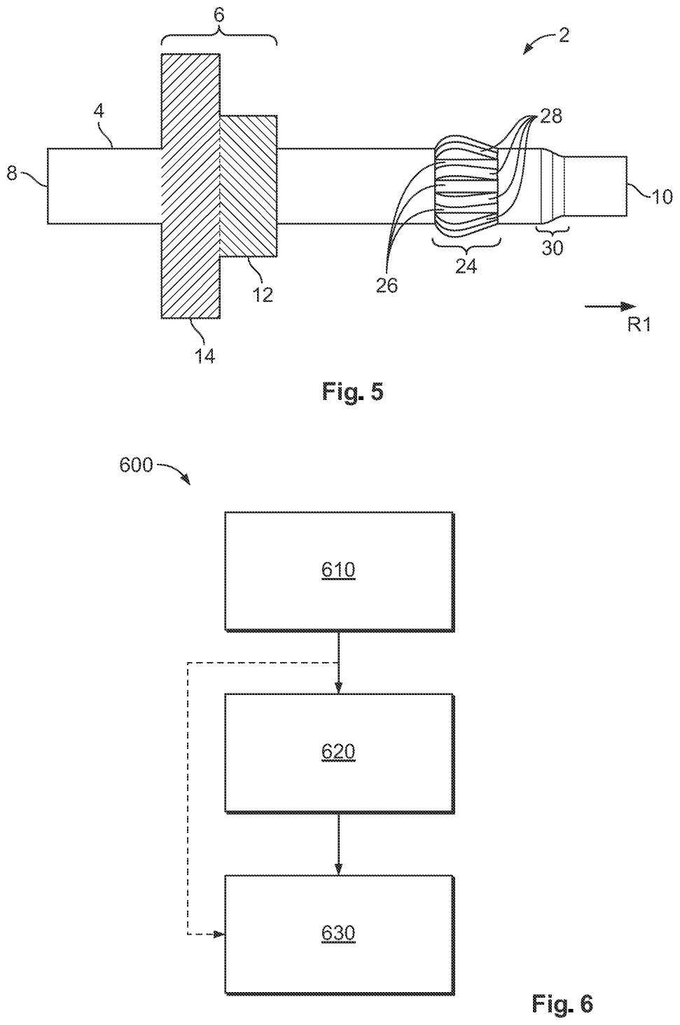

FIG. 5 shows a side view of the contact pin 2 with further optional features. The shown contact pin 2 extends in the longitudinal direction R1 of the contact wire from a first end 8 to a second end 10. Furthermore, a residual piece 6 of a bandoleer strip serving for impedance adaptation is arranged between the two ends 8 and 10 in the longitudinal direction R1 of the contact wire. Furthermore, the contact pin 2 may have a fastening section 24 between the residual piece 6 and one end 10. In other words, the fastening section 24 is arranged flush with the residual piece 6 in the longitudinal direction R1 of the contact wire. The fastening section 24 is preferably provided with indentations 26 and/or protrusions 28. The fastening section 24 serves to fasten the contact pin 2 within a shielding or an outer conductor accommodating the contact pin 2. Furthermore, the contact pin 2 or the contact wire 4 can have a gradation 30 in the longitudinal direction R1 of the contact wire between the second end 10 and the residual piece 6. The gradation 30 changes the cross-section of the contact wire 4. In the example shown, the cross-section of the contact wire 4 Decemberreases towards the second end 10.

For example, the contact wire 4 can be provided with the gradation 30 in order to make it easier to insert the contact pin 2 into another component (not shown here)—such as a socket—which receives the contact pin 2 at the second end 10.

FIG. 6 shows a flow diagram 600 of a manufacturing method of the contact pin.

In step 610, a residual piece of a bandoleer strip fitted with a contact wire is provided. The residual piece has a holding section and a mold section. Preferably, the holding section is sleeve-shaped. The holding section of the residual piece can have an electrically conductive connection with the contact wire. Furthermore, the mold section can be connected to the holding section via a material bridge. Furthermore, the mold section can be in electrically conductive contact with the contact wire over its entire length in the longitudinal direction of the contact wire.

In step 620, the mold section of the residual piece of the bandoleer strip can be cut depending on a calculated value serving for impedance adaptation. The cutting can be achieved by mechanical or thermal cutting processes, for example. For example, it can be done by punching, laser cutting or water jet cutting.

Alternatively or cumulatively, the mold section can be reshaped in step 630 depending on the calculated value serving for the impedance adaptation. If the method 600 comprises step 620, the reshaping in step 630 takes place after the mold section has been cut off in step 620. The reshaping may include manufacturing techniques such as rolling, open-die forging, die forging, extrusion, extrusion and/or bending of the molding section.

The calculated value can be determined by a simulation method depending on the geometric shape and physical expansion of a shielding that accommodates the contact pin. Advantageously, the mold section can be brought into such a form that signal losses are reduced. Preferably, signal losses are reduced in conjunction with a shielding of a coaxial cable.

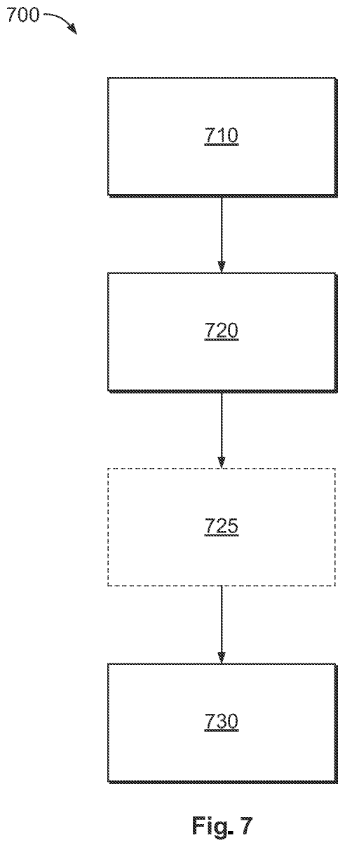

FIG. 7 shows a flow diagram 700 of a manufacturing method of the plug connector.

In step 710, a bandoleer strip 20 fitted with contact wires is provided. The bandolier strip 20 has a contact wire in a respective holding section of the bandolier strip 20. The holding sections are arranged adjacent to one another in a longitudinal direction of the bandolier band. It could also be said that the mold sections of adjacent contact wires, each of which is used to produce a contact pin, are connected to the respective mold section along the longitudinal direction of the bandolier band.

In step 720, the bandoleer strip 20 is cut off at a cut-off line 22 in order to obtain a residual piece 6 of the bandoleer strip 20 fitted with a contact wire. Preferably, there is exactly one contact wire between the free end of the bandoleer strip the cut-off line 22. In other words, the residual piece 6 is fitted with exactly one contact wire 4. The cut-off can preferably take place on only one side of the contact wire 4. Alternatively, the bandoleer strip 20 can be cut off at two opposite sides of the contact wire 4 in the longitudinal direction R2 of the bandoleer band. In this case, too, a residual piece with exactly one contact wire is obtained. In other words, the contact pin can be obtained in step 720 as described in the manufacturing method 600. Preferably, the distance of the cut-off line 22 to the contact wire, which is in the residual piece after the cut-off, corresponds to the calculated value serving for the impedance adaptation.

Preferably, the cut-off line 22 runs two contact wires arranged neighboring to each other in a longitudinal direction R2 of the bandoleer strip.

The cutting off in step 720 produces the contact pin.

In step 730, the contact pin or, in other words-the residual piece of the bandoleer strip fitted with the contact wire-is inserted into a shielding having a cross-sectional jump. Preferably, the residual piece is arranged in a longitudinal direction of the contact wire at a level of the cross-sectional jump of the shielding.

Optionally, the method 700 comprises a reshaping of the residual piece. As already explained, the residual piece preferably comprises a mold section serving for the impedance adaptation. In step 725, the mold section of the residual piece can be reshaped depending on a calculated value serving the impedance adaptation. The calculated value can be identical to a value characterising or corresponding to the cross-sectional jump of the shielding.

Furthermore, at least one part of the residual piece can serve on the contact pin as a guiding aide when inserting the contact pin into the shielding.

Furthermore, the method 700 can comprise an inserting of a seal between a free end of the contact pin and the residual piece serving for the impedance adaptation on the contact wire.

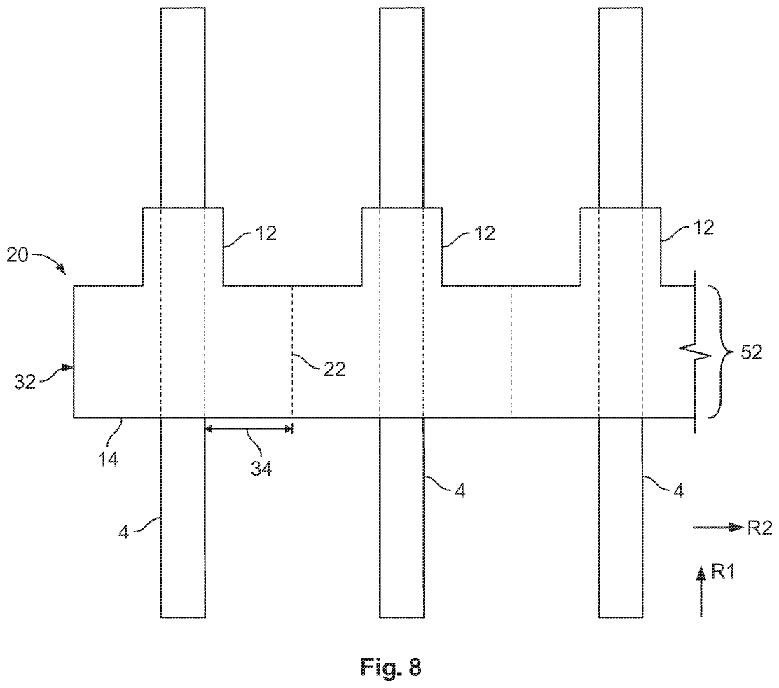

FIG. 8 shows a top view of a bandoleer strip 20 fitted with contact wires 4. The contact wires 4 are fastened or arranged in the respective holding sections 12 of the bandoleer strip 20. In FIG. 8, the respective holding sections are highlighted by hatching. Furthermore, a free end 32 of the bandoleer strip 20 is illustrated on the left-hand side as well as a cut-off line 22, which runs between 2 contact wires 4. In FIG. 8, the cut-off line 22 runs parallel to the longitudinal direction R1 of the contact wire. However, the cut-off line 22 can also run (on the bandoleer strip) inclined with respect to the longitudinal direction R1 of the contact wire. The mold section 14, associated with the contact wire 4 arranged at the free end 32, runs in a longitudinal direction R2 of the bandoleer band from the cut-off line 22 to the free end 32. FIG. 8 shows the distance of the cut-off line 22 to the contact wire 4 in a longitudinal direction R2 of the bandoleer band. The shown distance 34 runs between a proximal point of the contact wire to the cut-off line 22. However, the distance 34 can be used with respect to the center of the contact wire 4 instead of the proximal end of the contact wire. In this case, half the diameter 16 of the contact wire 4 is to be taken into account as offset. The distance 34 can be determined by a simulation method and in particular depending on the calculated value serving for the impedance adaptation.

Furthermore, FIG. 8 shows a band section 52 of the bandoleer strip, which extends along the longitudinal direction R2 of the bandoleer band and has neighboring form sections 14 in a continuous row.

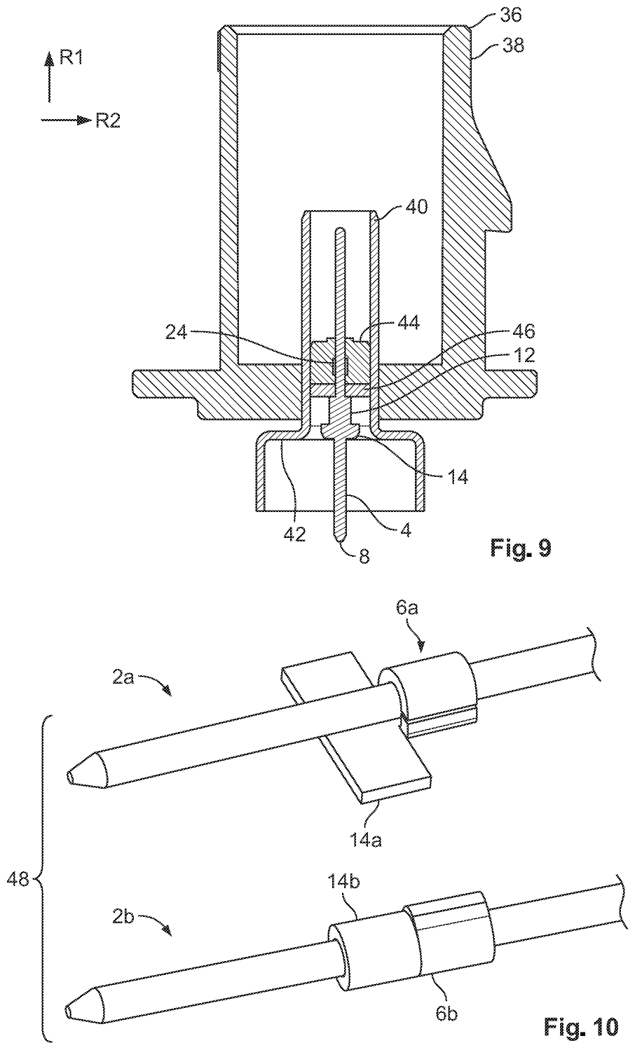

FIG. 9 shows a sectional view of an plug connector 36. The housing 38 is preferably formed hollow-cylindrical and thus has an axial direction R1, which corresponds to the preceding longitudinal direction R1 of the contact wire. Preferably, a shielding 40 is arranged centered or concentrically in the housing 38. The shielding 40 can also be designed as a hollow cylinder, whereby it has a cross-sectional jump in the axial direction R1. In other words, the shielding 40 can be described as two axially stacked hollow cylinders that are provided with different cross-sectional diameters and are connected via a material bridge at the cross-sectional jump 42. Preferably, the shielding 40 is rotation symmetrical with respect to the axial direction or the longitudinal direction R1 of the contact wire. The contact pin 2 is arranged in the contact pin receptacle of the plug connector. Preferably, the contact pin 2 is received as an inner conductor in the shielding 40. As already explained above, the cross-sectional jump 42 of the shielding 40 is located between two ends of the received contact pin 2. In particular, the mold section 14 can be arranged in a longitudinal direction R1 of the contact wire at the height of the cross-sectional jump 42.

Furthermore, one of the plug connectors 36 can have a fastening element 44. The fastening element 44 is preferably embodied ring shaped, so that the contact pin 2 can penetrate the fastening element 44. In other words, the fastening element 44 has a central opening. Furthermore, the fastening element 44 can have an integral seal 46. In this case, the seal 46 is a sealing ring, for example. The fastening element 44 is preferably inserted coaxially into the shielding 40 and at the same time accommodates the contact pin 2 in its central opening. Complementary surfaces to a fastening section 24 can be formed on the inner surfaces of the central opening of the fastening element 44 of the contact pin 2, so that the fastening element 44 holds the contact pin 2. Preferably, the fastening element 44 is arranged in the section with a smaller cross-sectional extension relative to the axial direction R1 of the plug connector.

Furthermore, in the longitudinal direction of the contact wire, a seal can be arranged in alignment between a free end of the contact pin 2 and the holding section 12. As explained above, the seal 46 can be embodied in particular as a sealing ring, which additionally protects the plug connector from moisture ingress.

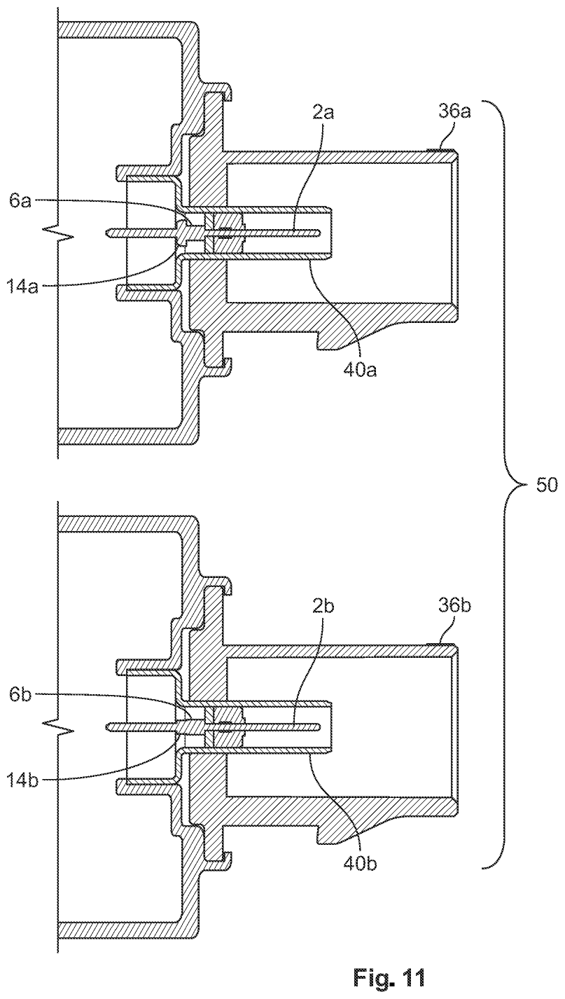

FIG. 10 shows a set 48 of the contact pins 2a and 2b. For the sake of simplicity, the set 48 of contact pins is shown with only two contact pins 2a and 2b. However, a set 48 of contact pins can contain any number of contact pins 2. For the contact pin 2a, the impedance adaptation element 6a is designed differently from the impedance adaptation element 6b of the other contact pin 2b. In particular, the two impedance adaptation elements 6a and 6b can be shaped geometrically different. Thus, for example, for the contact pin 2 the mold section 14a is designed as a plane-parallel board, whereas for the contact pin 2b the mold section 14b is circular shaped. In other words, the other mold section 14b is sleeve-shaped and differs in its geometric shape. In particular, the two mold sections 14a and 14b differ in their lateral extension transverse to the longitudinal direction R1 of the contact wire.

FIG. 11 shows a set 50 of the plug connectors 36. For the sake of simplicity, a set 50 with only two plug connectors 36a and 36b is shown here. However, a set 50 of the plug connectors may include any number of plug connectors 36. A sectional view of the plug connectors 36a and 36b is shown in FIG. 11. Both plug connectors each comprise an contact pin 2a and 2b. The contact pin 2a comprises an impedance adaptation element 6a with a mold section 14a. The contact pin 2b comprises an impedance adaptation element 6b with a mold section 14b. The contact pin 2a is inserted into the shielding 40a of the plug connector 36a, the contact pin 2b is inserted into the shielding 40b of the plug connector 36b. The plug connector 36a only differs from the plug connector 36b in the set 50 of plug connectors in that its impedance adaptation element 6a formed geometrically different than the impedance adaptation element 6b of the other connector 36b. Analogous to FIG. 10, for example, the mold section 14a an be designed as a plane-parallel board, whereas for the contact pin 2b the mold section 14b is circular shaped. Thus, also the expansion of the respective mold section 14a and 14b differs transversely to the longitudinal direction of the contact wire. Thus, a different impedance adaptation can be achieved already due alone to the different shape of the residual piece of the bandoleer strip or the impedance adaptation element 6.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A contact pin for a connector, comprising:
a contact wire extending between two ends,
an impedance adaptation element from a residual piece of a bandoleer strip,
wherein the impedance adaptation element is arranged between the two ends of the contact wire.

2. A contact pin according to claim 1, wherein the impedance adaptation element from the residual piece of the bandoleer strip comprises a holding section holding the contact wire and a mold section connected to the holding section via a material bridge and serving to adapt the impedance.

3. Contact pin according to claim 2, wherein the mold section consists of a residual of a cut-out band section of the bandoleer strip.

4. Contact pin according to claim 2, wherein the mold section comprises a plane-parallel board.

5. Contact pin according to claim 2, wherein the mold section has a curved shape in a cross-sectional plane perpendicular to a longitudinal direction of the contact wire.

6. Contact pin according to claim 5, wherein the mold section partially or completely encloses the contact wire.

7. Contact pin according to claim 5, wherein the center point of the contact wire in the cross-sectional plane perpendicular to the longitudinal direction of the contact wire is offset from a center point defining the curved shape of the mold section.

8. A set of the contact pins according to claim 1, wherein at least one impedance adaptation element in the set of contact pins is shaped geometrically different than an impedance adaptation element of another contact pin in the set of contact pins.

9. Plug connector comprising:
a contact pin including a contact wire extending between two ends and an impedance adaptation element from a residual piece of a bandoleer strip, wherein the impedance adaptation element is arranged between the two ends of the contact wire; and
a shielding receiving the contact pin as an inner conductor, wherein the shielding has a cross-sectional jump between the two ends of the contact pin along a longitudinal direction of the shielding;
wherein the impedance adaptation element of the contact pin is arranged in a longitudinal direction of the contact wire at a level of the cross-sectional jump of the shielding.

10. Plug connector according to claim 9, wherein the impedance adaptation element from the residual piece of the bandoleer strip comprises a holding section holding the contact wire and a mold section connected to the holding section via a material bridge and serving to adapt the impedance, wherein the shielding has a section with a larger cross-section in the longitudinal direction after the cross-sectional jump than before the cross-sectional jump and wherein the section of the shielding with a larger cross-section partially or completely encloses at least the mold section of the contact pin.

11. Plug connector according to claim 9, wherein the impedance adaptation element from the residual piece of the bandoleer strip comprises a holding section holding the contact wire and a mold section connected to the holding section via a material bridge and serving to adapt the impedance, wherein the mold section has a curved shape in a cross-sectional plane perpendicular to a longitudinal direction of the contact wire.

12. Plug connector according to claim 9, wherein the impedance adaptation element from the residual piece of the bandoleer strip comprises a holding section holding the contact wire and a mold section connected to the holding section via a material bridge and serving to adapt the impedance, wherein the mold section partially or completely encloses the contact wire.

13. A set of the plug connectors according to claim 9, wherein a first contact pin of a first plug connector in the set of plug connectors comprises an impedance adaptation element shaped geometrically different than a second contact pin of a second plug connector in the set of plug connectors.

14. A method for manufacturing a contact pin comprising:
providing a residual piece of a bandoleer strip fitted with a contact wire, wherein the contact wire is fastened in a holding section of the residual piece of the bandoleer strip and wherein the residual piece comprises a mold section connected to the holding section via a material bridge; and
cutting and/or reshaping the mold section depending on a calculated value that serves to adapt an impedance.

15. A method for manufacturing a plug connector comprising:
providing a bandoleer strip fitted with contact wires, wherein respectively one contact wire is arranged in a respective holding section of the bandoleer strip;
cutting the bandoleer strip at a cut-off line in order to obtain a residual piece of the bandoleer strip fitted with the corresponding contact wire, wherein the cut-off line on the bandoleer strip runs between two contact wires arranged adjacent in a longitudinal direction of the bandoleer strip; and
inserting the residual piece of the bandoleer strip fitted with the corresponding contact wire into a shielding having a cross-sectional jump, wherein the residual piece is arranged in a longitudinal direction of the contact wire at a level of the cross-sectional jump of the shielding.

16. The method according to claim 15, wherein the residual piece additionally comprises a mold section serving to adapt an impedance, further comprising:
reshaping of the mold section of the residual piece depending on a value corresponding to the cross-sectional jump of the shielding.

17. Method according to claim 15, wherein, when inserting the residual piece of the bandoleer strip fitted with the contact wire, the residual piece serves as a guiding aid.
